(19) United States
(12) Patent Application Publication
(10) Pub. No.: US 2025/0245542 A1
(43) Pub. Date: Jul. 31, 2025

(54) Method and System for Assigning a Label to an Input Vector of Features Given Labeling Task using Quantum Computation

(71) Applicant: Terra Quantum AG, St. Gallen (CH)

(72) Inventors: Asel SAGINGALIEVA, St. Gallen (CH); Mohammad KORDZANGANEH, St. Gallen (CH); Alexey MELNIKOV, St. Gallen (CH)

(73) Assignee: Terra Quantum AG, St. Gallen (CH)

(21) Appl. No.: 18/388,637

(22) Filed: Nov. 10, 2023

(51) Int. Cl. G06N 10/60

(52) U.S. Cl. CPC G06N 10/60

(57) ABSTRACT

A method for labeling an input vector of features with an output label using a variational quantum circuit given a labeling task includes separating the input vector of features into a plurality of sub-vectors of input data, initializing a plurality of computation qubits in an initial state, and subjecting the plurality of computation qubits to a plurality of layers of quantum gates, wherein each layer of the plurality of layers of quantum gates comprises an entangling gate a plurality of encoding gates for encoding the features of one of the sub-vectors into the computation qubits, and a plurality of variational gates, wherein the sub-vectors of input data for two different layers of quantum gates are different, and wherein variational parameters associated with the variational gates are optimized for predicting an optimal output label for the input vector of features in view of the labeling task according to a training algorithm.

### FIELD OF THE DISCLOSURE

The present disclosure relates to quantum computing and, more particularly, to a hybrid quantum-classical computation system as part of a trainable classification system for assigning a label to an input vector of features.

### BACKGROUND OF THE INVENTION

Quantum computers provide a platform of controllable quantum mechanical systems whose state and interaction can be controlled in order to perform a computation. The computation is realized by a deterministic evolution of the controllable quantum mechanical systems, and the state of the quantum mechanical systems can be measured to determine the outcome of the computation.

The quantum computer generally encodes information in so called qubits, acting as a quantum mechanical equivalent of classical bits. Qubits are physical systems whose quantum mechanical state can be (coherently) controlled and (substantially) preserved between two basis states during the time of a computation, in the following referred to as |0> and |1>. As an example, a qubit may be implemented by encoding information in the spin state of an electron, e.g., in the electron being in an “up” state or a “down” state but may also be encoded in a polarization state of a photon, in states of a (superconducting) oscillator, in energy levels of an atom, or the like.

Control operations on these qubits are termed Quantum gates. Quantum gates can coherently act on qubits for inducing changes of the state of a single qubit (so called single-qubit gates) and for acting on multiple qubits (so called multi-qubit gates), e.g., to entangle the states of the multiple qubits, and any combination thereof. For example, a single-qubit gate may induce a rotation of the spin state of an electron by a selectable value, e.g., π/2. A multi-qubit gate may coherently act on two or more qubits, such as a coherent CNOT operation on the state of two qubits. A plurality of quantum gates can be applied to the qubits of the quantum computer in parallel or in sequence for performing a computation. Finally, the state of the qubits may be measured repeatedly after applying a sequence of quantum gates to determine the probabilities for each possible outcome of the computation.

In order to compute solutions to problems which are considered intractable on classical computers, a quantum computer can leverage the special properties of quantum mechanical states, in particular the superposition and entanglement of different quantum states, to find solutions with a comparatively low number of calculation steps or access a large internal state space.

However, the superposition/entangled states of quantum mechanical systems are inherently volatile (e.g., suffer from decoherence) and the control and measurement of these systems is subject to fidelity margins, such that state-of-the-art quantum computers are currently limited both in the number of controllable quantum mechanical systems (qubits) as well as the number of successively performed control actions (quantum gates).

Despite these shortcomings, promising applications for near term available quantum processors exist, i.e., noisy intermediate-scale quantum (NISQ) devices, such as variational quantum algorithms. In variational quantum algorithms, the action of the quantum gates is parametrized in terms of variational parameters, and the variational parameters may be systematically varied with the help of a classical computing resource, in a manner analogous to machine learning, e.g., by implementing a kernel method for classifying an input using a variational quantum circuit. By varying the variational parameters to extremize a cost/loss function, which attributes a cost to the output of the variational quantum circuit with respect to an optimal solution, an output of the variational quantum circuit can be “trained” to provide an optimal solution to an unseen set of inputs. In these applications, entanglement between different qubits may give access to a large internal state space to provide “quantum advantage.”

### BRIEF SUMMARY OF THE INVENTION

A variational quantum circuit can be used as a classifier by encoding an input vector of features into quantum states of qubits of a qubit register, applying the variational gates of a variational quantum circuit to the quantum states of the qubits and by measuring quantum states of the qubits as a measured output of the variational quantum circuit. An output label for the input vector of features may then be determined based on the measured output of the variational quantum circuit.

The variational parameters may be optimized to increase a quality of the output label for the input vector of features given the labeling task based on an optimization algorithm in a manner analogous to machine learning algorithms, a process which is often referred to as a training algorithm.

To encode an input variable into a quantum circuit for classification, a state of a qubit of the qubit register may be varied based on the input variable, e.g., based on a control operation parametrized by the input variable or based thereon, such as a quantum state rotation by an angle, which can be determined based on the input variable.

According to a first aspect, a method for labeling an input vector of features with an output label using a variational quantum circuit given a labeling task is provided. The method comprises separating the input vector of features into a plurality of sub-vectors of input data; initializing a plurality of computation qubits in an initial state; and subjecting the plurality of computation qubits to a plurality of layers of quantum gates. Each layer of the plurality of layers of quantum gates comprises an entangling gate for entangling quantum states of at least two qubits of the computation qubits, a plurality of encoding gates for encoding the features of one of the sub-vectors into the computation qubits, and a plurality of variational gates acting on the computation qubits according to a variational parameter associated with the respective layer and variational gate. The sub-vectors of input data for two different layers of quantum gates are different, and the variational parameters are optimized for predicting an optimal output label for the input vector of features in view of the labeling task according to a training algorithm.

### BRIEF DESCRIPTION OF THE SEVERAL VIEWS OF THE DRAWING(S)

The features and numerous advantages of the methods and system according to the present disclosure will best be understood from a detailed description of detailed embodiments with reference to the accompanying drawings.

FIG. 1 is a block diagram of an exemplary embodiment of a hybrid quantum computation system in accordance with the disclosure.

FIG. 2 is a block diagram of an additional exemplary embodiment of a hybrid quantum computation system in accordance with the disclosure.

FIG. 3 is a flowchart for a method of labeling an input vector features with an output label using a variational quantum circuit given a labeling task in accordance with the disclosure.

FIG. 4 is a block diagram of an additional example embodiment of a hybrid quantum computation system in accordance with the disclosure.

FIG. 5 is a block diagram of an additional exemplary embodiment of a hybrid quantum computation system in accordance with the disclosure.

FIG. 6 is a flowchart for a method for training a quantum computation system to label an input vector of features with an output label using a variational quantum circuit given a labeling task in accordance with the disclosure.

FIG. 7 is a diagram of an application case for a hybrid quantum-classical computation system implementing and driving a variational quantum circuit similar to the example of FIG. 5.

FIG. 8 is a block diagram of another exemplary embodiment of a hybrid quantum computation system in accordance with the disclosure.

FIG. 9 is a chart containing simulation results after the training of the simulated hybrid quantum-classical classification system schematically shown in FIG. 8.

FIG. 10 is a chart containing simulation results of training the hybrid and classical models with the same hyperparameters on a different amount of training data in accordance with the disclosure.

### DETAILED DESCRIPTION OF THE INVENTION

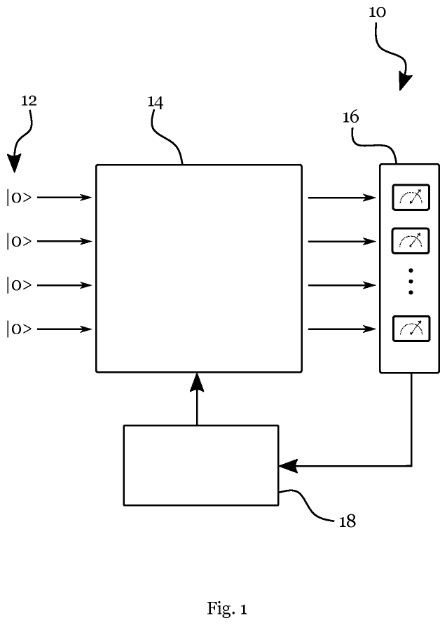

FIG. 1 schematically illustrates an example of a hybrid quantum-classical computation system 10 for implementing and driving a variational quantum circuit, according to a schematic quantum circuit diagram. The schematic quantum circuit diagram depicts an evolution of quantum states from left to right for an exemplary number of computation qubits, wherein control operations on the qubits can be arranged along lines of qubit state evolution to indicate an architecture or time-sequence associated with the quantum circuit. The skilled person will appreciate that additional coherent operations may be included as part of the quantum circuit, and the quantum circuit may be extended to an arbitrary number of qubits. Further, although reference may be made to specific control operations in the following description, the skilled person will appreciate that different control operations may be used to implement the system and methods of the present disclosure, e.g. depending on the physical representation of the qubits.

The illustrated system 10 of FIG. 1 comprises a qubit register 12 comprising a plurality of computation qubits. A plurality of quantum gates 14 may act on the computation qubits of the qubit register 12 to perform a computation/controlled evolution, wherein variable actions of the plurality of quantum gates 14 may be parametrized by variational parameters. The outcome of the computation may be measured by a measurement sensor 16 which projects the states of the computation qubits onto the computational basis states of the hybrid quantum-classical computation system 10. The outcome can be received by a control system 18.

The control system 18 may be configured to repeatedly perform a computation sequence. The computation sequence may comprise initializing the computation qubits of the qubit register 12 before each computation, such as into the ground state of each computation qubit, e.g., to form an initial state of the computation qubits of |00 . . . 0>.

The control system 18 may then apply the plurality of quantum gates 14 to the computation qubits of the qubit register 12 to drive a coherent evolution of the computation qubits. The control system 18 may optionally produce superposition states of all computation qubits, e.g., by applying a Hadamard gate to each of the computation qubits and may subsequently apply the plurality of quantum gates 14 including variational quantum gates with the variable actions.

Following the coherent evolution, the state of the computation qubits in the qubit register 12 may be measured with the sensor 16. The measurement sensor 16 may be a plurality of single qubit state detectors for measuring the state of each computation qubit following the evolution according to the plurality of quantum gates 14. Repeating the measurement may allow determining the probability of each measurement outcome and the result may be employed for assigning a label to an input vector of features. On the basis of the measured output, the control system 18 can classically calculate an “energy”/“cost” of the label with a cost function based on the labeling task. The labeling task may be specified according to a function, which assigns a cost to the measured output, or to the label derived therefrom, or may be specified according to pairs of sample input vectors of features and sample labels, wherein the cost may be based on a difference between the output label and the sample label.

Conventionally, the controller 18 may repeat the computation sequence with adjusted variable actions based on the outcome, such as to progressively improve the quality of an output label associated with the measured outcome. For example, the control system 18 may repeat the computation sequence with adjusted operation parameters for the variational quantum gates in order to determine a gradient or energy landscape associated with the plurality of quantum gates 14 from the measured outcomes and may update the variational parameters based on the estimated gradient in order to progressively adjust the variational quantum circuit towards an improved solution.

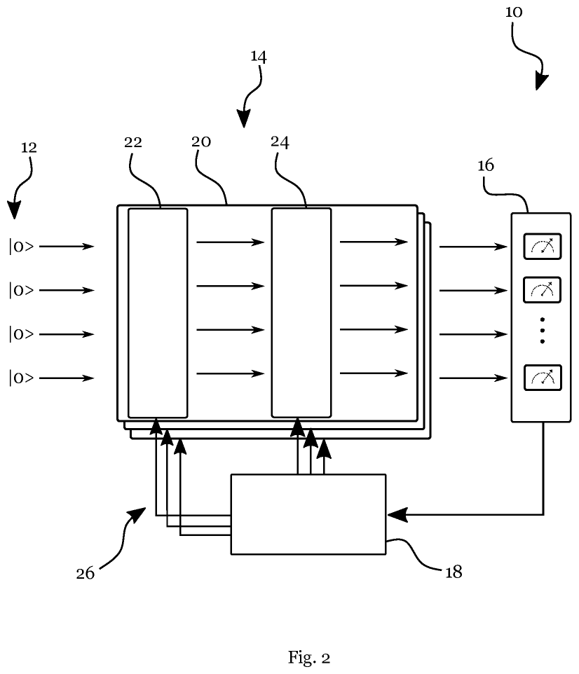

FIG. 2 illustrates another example of a hybrid quantum-classical computation system 10 for implementing and driving a variational quantum circuit. The system 10 comprises a qubit register 12 comprising a plurality of computation qubits. A plurality of quantum gates 14 are arranged in layers of quantum gates 20, which may act on the computation qubits of the qubit register 12 in sequence to perform a computation. Each layer of quantum gates 20 comprises an encoding layer 22 and a variational layer 24, wherein the variational layer 24 comprises a plurality of variational quantum gates whose actions may be parametrized by different variational parameters in each layer of quantum gates 20. The encoding layer 22 comprises a plurality of encoding gates whose action is parametrized based on values of an input vector of features to be labeled according to a given labeling task. The encoding layer 22 in different layers of quantum gates 20 may be based on different sub-vectors 26 of the input vector of features, such that different layers of quantum gates 20 may encode different values of the input vector of features into the states of the computation qubits. Each layer of quantum gates 20, e.g., as part of each variational layer 24, may comprise multi-qubit gates for entangling the states of different computation qubits of the qubit register 12, such as a plurality of CNOT gates, as entangling gates for entangling quantum states of at least two qubits of the computation qubits.

The application of the variational layer 24 to the states of the computation qubits 24 after the action of the encoding layer 22 may prepare the quantum states of the computation qubits for the encoding of a different feature of the input vector of features in the next layer of quantum gates 20.

The outcome of the computation may be measured by a measurement sensor 16 after all layers of quantum gates 20 have acted on the computation qubits, wherein the measurement sensor 16 may project the states of the computation qubits onto the computational basis states of the hybrid quantum-classical computation system 10. Based on a measured output, which may be determined based on a measurement outcome obtained with the measurement sensor 16 or based on the measurement outcomes obtained with the measurement sensor 16 in multiple repetitions of applying the variational quantum circuit to the computation qubits, the control system 18 may determine an output label for labeling the input vector of features according to the given labeling task. The variational parameters should be optimized for predicting an optimal output label for the input vector of features in view of the labeling task according to a training algorithm, which may be an iterative process of updating the variational parameters according to an estimated gradient associated with the plurality of quantum gates 14.

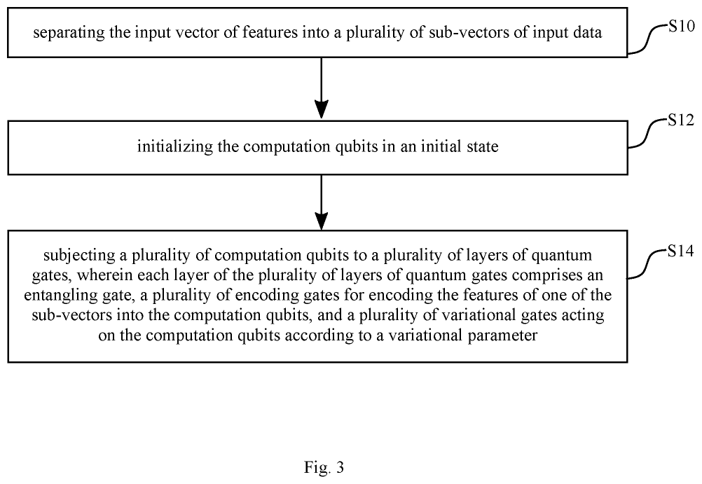

FIG. 3 illustrates a schematic flowchart for a method of labeling an input vector of features with an output label using a variational quantum circuit given a labeling task, which may be implemented by the system 10 of FIG. 2. The method comprises separating the input vector of features into a plurality of sub-vectors of input data 26 (S10) and initializing the computation qubits in an initial state (S12). The method further comprises subjecting the plurality of computation qubits to a plurality of layers of quantum gates 20, wherein each layer of the plurality of layers of quantum gates 20 comprises an entangling gate, a plurality of encoding gates for encoding the features of one of the sub-vectors 26 into the computation qubits, and a plurality of variational gates acting on the computation qubits according to a variational parameter (S14) associated with the respective layer and variational gate.

The sub-vectors of input data 26 for two different layers of quantum gates 20 are different, and the variational parameters are optimized for predicting an optimal output label for the input vector of features in view of the labeling task according to a training algorithm.

The method may enable the labeling of large input vectors of features, e.g., input vectors of features received from a classical machine-learning network, with a limited number of computation qubits. Given a maximum number of qubits or a maximum depth of a quantum circuit in a given quantum computation architecture, a number of input features N in the input vector of features may be divided into a plurality of sub-vectors of input data 26. Each of the sub-vectors of input data 26 may be encoded by an encoding layer 22 of one of the layers of quantum gates 20, such that an encoding of the input vector of features is spread over the application of multiple layers of quantum gates 20. The input vector of features may be provided as a set of data values and a processing system 18 may prepare a plurality of sub-vectors of input data 26, which each may be formed of a subset of the set of data values, for encoding as part of the application of the plurality of layers of quantum gates 20, with different sub-vectors of input data 26 being encoded by encoding layers 22 of different layers of quantum gates 20.

In between the encoding layers 22 encoding different sub-vectors of input data 26, variational gates of a variational layer 24 and entangling gates, which may be part of the variational layer 24, may act on the computation qubits of the qubit register 12. The application of the variational layer 24 to the state of the computation qubits may enable a different processing of the different values of the input vector of features according to variational parameters obtained during the training process. Entangling gates and variational layers 24 inserted between each encoding layer 22 may ensure maximum Fourier accessibility of the state space of the computation qubits for the labeling task.

In some examples, each variational layer 24 comprises a state rotation according to a variational parameter and an application of an entangling gate, such as a CNOT gate, to each of the computation qubits.

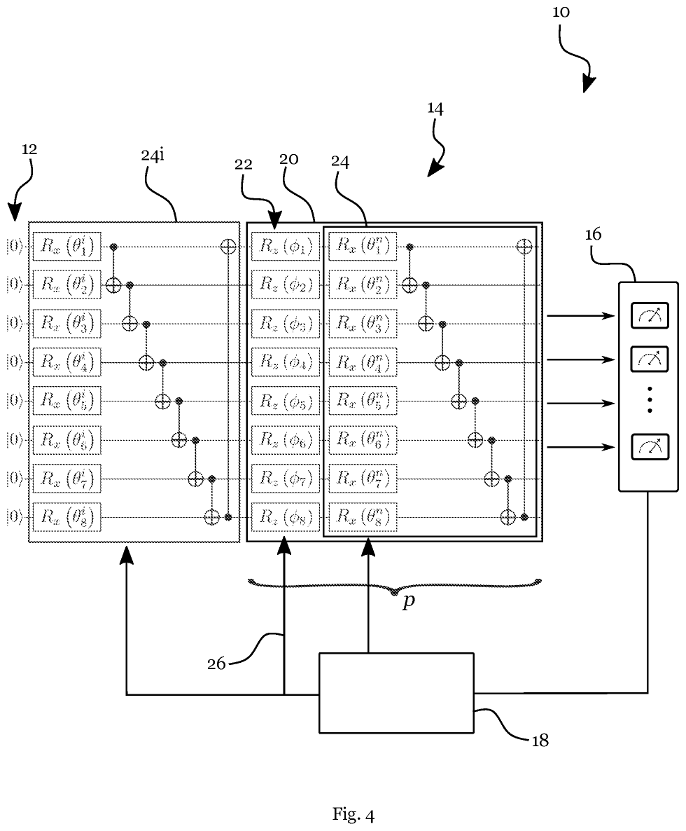

FIG. 4 illustrates another schematic example of a hybrid quantum-classical computation system 10 for implementing and driving a variational quantum circuit similar to the system 10 of FIG. 2. The system 10 comprises a plurality of qubits in a qubit register 12, which are initialized into their respective ground states, e.g., |0>. A control system 18 may subsequently apply an initial variational layer 24i to the states of the qubits, which may prepare the qubits for a subsequent action of a plurality of layers of quantum gates 20.

The initial variational layer 24 may comprise a variational quantum gate parametrized by a corresponding variational parameter θ₁ⁱ, θ₂ⁱ, . . . , θ₈ⁱ with each variational quantum gate acting on a corresponding one of an exemplary number of 8 qubits. In the illustrated example, the variational quantum gate is implemented as a rotation of the qubit state about an x-axis according to an Rx rotation operation, with the variational parameters θ₁ⁱ, θ₂ⁱ, . . . , θ₈ⁱ defining respective rotation angles.

The initial variational layer 24i further comprises 8 two-qubit gates coupling a quantum state of each qubit with its next neighbor, if the qubits are arranged in a line, with the last and first qubit being also subjected to the action of a common two-qubit gate. In the illustrated example, the two-qubit gates may be implemented as CNOT gates indicated by vertical lines in between the horizontal lines, which terminate on black dots/hollow circles with crossed lines. The dots/circles can indicate the conditionality of the two-qubit gate operation, e.g., with the black dot indicating the control qubit and the hollow circle with crossed lines indicating the target qubit, such that if the control qubit is in a certain state, e.g., |1>, then the state of the target qubit may be manipulated, e.g. flipped in the case of the CNOT gate.

The layers of quantum gates 20 applied to the states of the qubits after the initial variational layer 24 has been applied may comprise a variational layer 24 of a similar layer architecture, e.g. with the same arrangement or selection of quantum gates, but the action of the variational layer 24 may be different based on different variational parameters θ₁^{1-p}, θ₂^{1-p}, . . . , θ₈^{1-p} for each of the layers of quantum gates 20, which may be numbered 1-p based on a running index n, indicating the respective layer of a number of p layers of quantum gates 20.

Further each one of the layers of quantum gates 20 comprises an encoding layer 22 applied to the state of the qubits, wherein each encoding layer 22 in the illustrated example comprises a number of encoding gates equal to the number of qubits, i.e., one encoding gate per qubit of the variational quantum circuit. The encoding gates may be implemented by single-qubit gates, e.g., qubit state rotation, such as the R_{z} rotations of the qubit state about the z-axis in the illustrated example. The rotation axis of the encoding gates may be different from the rotation axis of the variational quantum gates when both gates are implemented as single-qubit rotations as in the illustrated example.

The action of the plurality of encoding gates in the encoding layer 22 on the states of the qubits may be based on corresponding encoding angles φ₁₋₈ for each one of the encoding gates. The encoding angles φ₁₋₈ may be different for different layers of quantum gates 20. In some examples, the system may encode a number of p*N encoding angles, wherein p is the number of layers of quantum gates 20 and N is the number of computation qubits to which the layers of quantum gates are applied. In some examples, the same sub-vectors 26 of data are encoded in different layers of quantum gates 20, such that a data-reuploading is performed based on the repeated application of the encoding gates in different layers of quantum gates 20. In some examples, data re-uploading can comprise scaling the values encoded in the encoding layers 22 differently based on different scaling factors for different layers of quantum gates 20, such as to implement an exponential encoding of the respective features.

The skilled person will appreciate that the number of computation qubits may be smaller than the number of qubits which are affected by the application of a quantum circuit in the system 10, e.g., based on the provision of additional ancilla qubits for implementing certain quantum operations. Rather, the computation qubits may be understood as the qubits, which are directly manipulated based on the action of the variational gates or the encoding gates.

After the encoding of a sub-vector 26 of data based on the action of the encoding layer 22, the qubits are subjected to the variational layer 24. In some examples, the qubits are subjected to a plurality of variational layers 24 with different variational parameters after the action of an encoding layer 22 and before the action of the encoding layer 22 of the next layer of quantum gates 20.

After the layers of quantum gates 20 have acted on the qubits, the state of the qubits may be measured by corresponding sensors 16, such as a projective measurement of the state of all qubits. The skilled person will appreciate that all or only a sub-set of the qubits may be measured or used to determine the output label based on measured outputs of the sensor 16, e.g., depending on the dimension of the output label according to the labeling task.

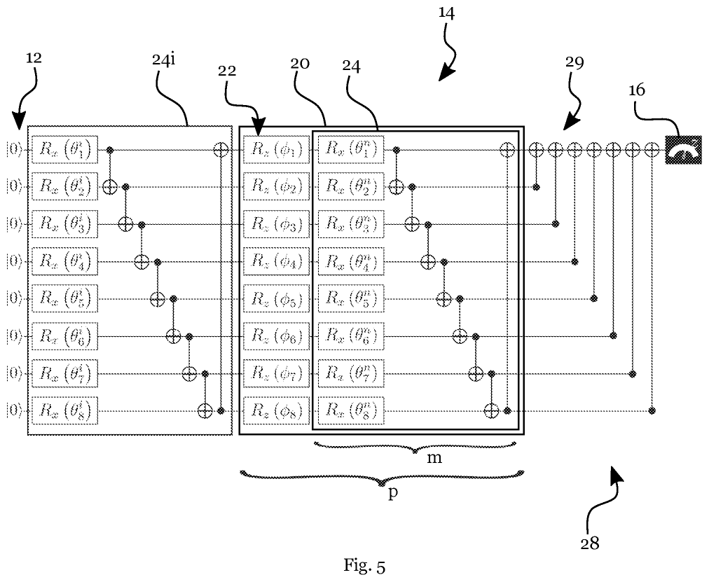

FIG. 5 illustrates another schematic example of a variational quantum circuit 28 similar to the variational quantum circuit 28 in the example of FIG. 4. In the example of FIG. 5, after the variational quantum circuit 28 comprising the initial variational layer 24i and the layers of quantum gates 20 described in conjunction FIG. 4 have acted on the qubits of the qubit register 12, a plurality of multi-qubit gates 29 are applied to the states of the qubits. Each of the p layers of quantum gates 20 comprises a number of m variational layers 24, which are applied to the states of the qubits between the encoding layers 22 of adjacent layers of quantum gates 20, wherein m can in principle be any integer number, such as one variational layer 24 or a plurality of variational layers 24.

After the variational quantum circuit 28 has acted on the qubits, the first qubit in the qubit register 12 is subjected to the action of a CNOT operation with each one of the other qubits on which the variational quantum circuit 28 has acted, and is subsequently measured to obtain a single measured output. As the state of the first qubit is quantum mechanically entangled with the states of the other qubits on which the variational quantum circuit 28 has acted, the measured output may depend on the state of all qubits or may be affected by all features of the input vector of features. The single measured output may be used to determine the output label. The states of the other qubits may also be measured, but their values may be discarded or may be used to post-select the measured outputs obtained from measuring the first qubit.

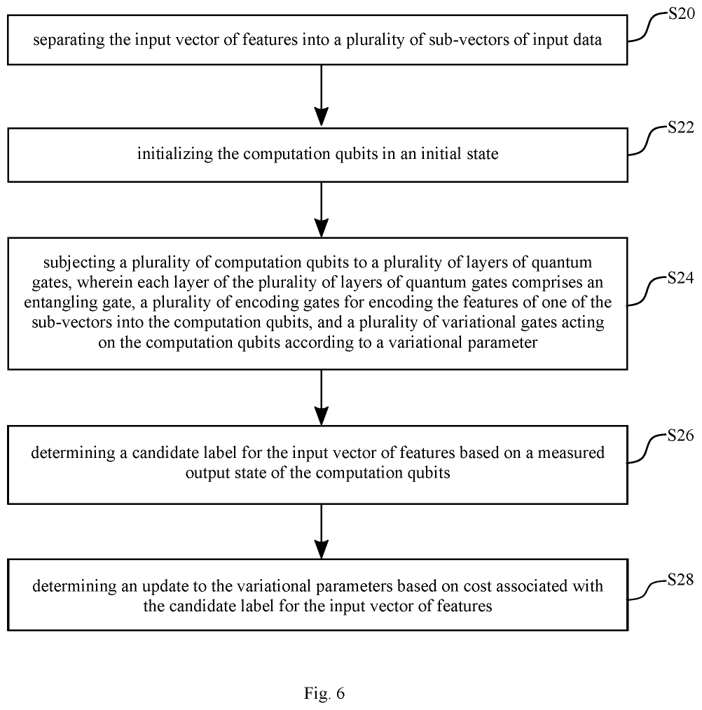

FIG. 6 illustrates a flowchart of a method for training a quantum computation system 10 to label an input vector of features with an output label using a variational quantum circuit 28 given a labeling task, wherein the quantum computation system comprises a plurality of computation qubits and a control system 18. The method comprises an iterative process of separating the input vector of features into a plurality of sub-vectors of input data 26 (S20), initializing the computation qubits in an initial state (S22), subjecting a plurality of computation qubits to a plurality of layers of quantum gates (S24), determining a candidate label for the input vector of features based on a measured output state of the computation qubits (S26), and determining an update to the variational parameters based on cost associated with the candidate label for the input vector of features, wherein the cost is determined based on a cost function (S29).

Each layer of the plurality of layers of quantum gates 20 comprises an entangling gate for entangling quantum states of at least two qubits of the computation qubits, a plurality of encoding gates for encoding the features of one of the sub-vectors into the computation qubits, and a plurality of variational gates acting on the computation qubits according to a variational parameter associated with the respective layer and variational gate. The sub-vectors of input data 26 for two different layers of quantum gates 20 are different.

The hybrid quantum-classical computation system 10 may be trained based on a training dataset of sample data, which may comprise a plurality of sample input vectors of features and corresponding sample output labels. Initially, all trainable parameters of the hybrid quantum-classical computation system 10, i.e., the variational parameters, may be initialized, e.g., as random values. Further, a cost function, i.e., a loss function, such as the mean squared error (MSE) may be selected for quantifying a quality of the output label.

Subsequently, the sample input vectors of features may be passed to the hybrid quantum-classical computation system 10 and the gradient of the cost function may be tracked based on the MSE between the output label produced by the hybrid quantum-classical computation system 10 and the sample output label. The gradient may be determined with respect to all the variational parameters and the average gradient for all the data points may be used to update the trainable parameters, e.g., based on an optimization algorithm, such as the adaptive moment estimation algorithm (Adam). The iterative training process may terminate at any point during the training, e.g., if the cost function reaches a certain value, reaches a plateau, or is stuck in a loop about a point in the parameter space. The skilled person will appreciate that it may not be necessary to evaluate the cost function at each iterative step, but it may be sufficient to compute the gradient during the training.

In some examples, determining the parameter update for the variational parameters comprises determining a vector of derivatives for the variational parameters as part of a parameter update gradient.

The trainable parameters may be updated based on the parameter update gradient, wherein a subset or all of the trainable parameters may be modified based on a value of the gradient and a value for a learning rate quantifying a size of an update step. In some examples, determining the parameter update is based on stochastic gradient descent, and may be including a momentum coefficient based on a previously determined gradient of the cost function.

The gradient of the cost function for the variational parameters may be accessible through the parameter shift rule, in which the variational quantum circuit 28 is evaluated with shifted variational parameters in order to determine partial derivatives of the cost function with respect to the shifted variational parameters.

In some examples, the method comprises determining a vector of derivatives for the variational parameters, wherein determining the vector of derivatives may comprise applying the parameter shift rule to a subset of or all of the variational gates at each iteration of the iterative process.

Specifically, for quantum gates with eigenvalues±½, e.g. one-qubit rotation generators in ½ {σₓ, σ_{y}, σ_{z}}, the partial derivative of a function f with respect to a variational parameter θⱼ may be determined according to ∂_{θ}_{ⱼ}f=r(f(θⱼ+π/2)−f(θⱼ−π/2)).

However, the skilled person will appreciate that the variational parameters can equally be optimized in an optimization algorithm without access to the derivatives, e.g., by (randomly) sampling the cost function, such as in the Constrained Optimization By Linear Approximation (COBYLA) algorithm or similar algorithms, and the gradient may be an estimated gradient based on an estimate of the energy landscape of the cost function.

The cost function may then be minimized/maximized by iteratively updating the trainable parameters according to the determined/estimated gradient of the cost function with respect to the trainable parameters, e.g., with an adaptive moment-based update function.

In some examples, determining the parameter update is based on an update function of a moving average over a gradient of the cost function and of a moving average over the squared gradient of the cost function.

As the adaptive moment-based update function depends on the moving average over the gradient of the cost function and the (element) square of the moving average over the gradient of the cost function, the update of the variational parameters may be smoothed by first order and second order moments of the gradient, enabling the descent towards an optimized solution also for a “noisy” quantum system.

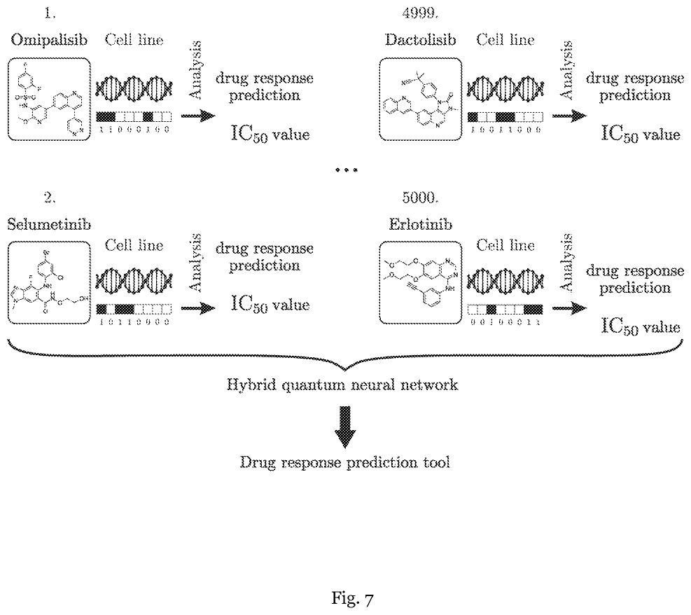

FIG. 7 schematically illustrates a labeling task for a hybrid quantum-classical computation system 10 implementing and driving a variational quantum circuit 28 similar to the example of FIG. 5. The labeling task is defined as: given an input vector of features obtained based on a combination of a parametrization of a patient's cell line and a given drug, predict an indicator for the drug efficiency for treating the specific patient with the given drug, such as the IC₅₀ response of the specific patient to the given drug. This application may reduce or eliminate the need for extensive clinical tests and may therefore dramatically affect people's well-being. When it comes to personalized medicine, including predicting drug responses, collecting data may be a challenge, such that the labeling task may be improved based on the use of hybrid quantum-classical computation system 10, which may rely on a lower number of machine-learning parameters for accurately predicting a response, and may also require less training data.

For the exemplary labeling task schematically illustrated in FIG. 7, a machine learning system comprising a hybrid quantum-classical computation system 10 may be trained based on the GDSC dataset containing information on mutations in genomes that can be matched with different types of cancer, as well as the chemical formula of drug molecules. The labeling task may therefore be considered as predicting how the mutation will respond to the drug, e.g., how effective the drug will be for a given patient.

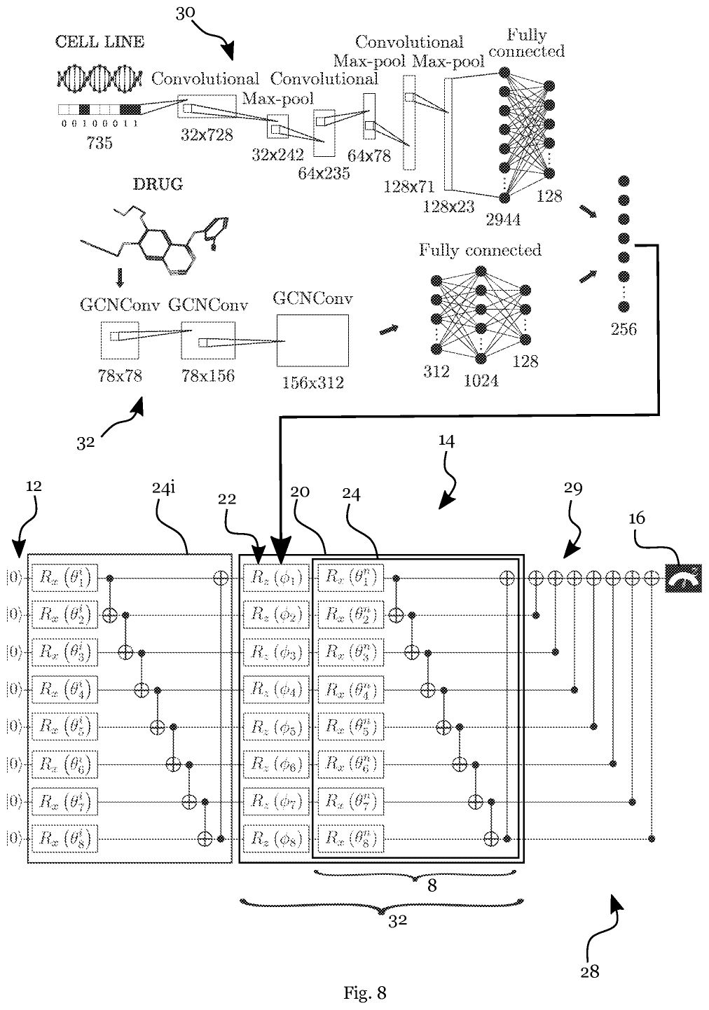

FIG. 8 illustrates a modified hybrid quantum-classical computation system 10 based on the variational quantum circuit 28 illustrated in FIG. 5 for a labeling task similar to the example provided in FIG. 7.

In addition to the variational quantum circuit 28 of FIG. 5, the system 10 further comprises two machine learning models 30, 32 for processing input data from the GDSC database.

A first model 30 processes a feature indicative of a mutation in a cancerous cell. In biology, a cell line is a population of human cells that normally would not multiply indefinitely, however, because of the gene mutation these cells may avoid cellular aging and may instead continue to divide infinitely. The cell line may represent the tumor itself as a binary vector, where 1 indicates the presence of genomic mutation. The first model 30 comprises a one-dimensional convolutional layer to encode the cell line's genomic features which are represented in the form of one-hot encoding namely a 735-dimensional binary vector. The resulting feature map can be passed through a Max Pooling layer in order to reduce a spatial volume of the map. After three repetitions of the convolutional layers, the final fully connected layer flattens the output into a vector of features of dimension 128.

The second model 32 comprises a graph convolutional network for processing features indicative of a certain drug. The drug can be represented as a graph in the format of SMILES, using the PubChem library. In this format, the drug can be written in a line. Each node of the graph may contain information describing its graphical and chemical representation, including the atom type, the chemical bonds, the branching of the molecule, its configuration, its isotopes, or a combination thereof. The atom type can be encoded with the standard abbreviation of the chemical elements, the bonds can be represented with special symbols, branches can be described with parentheses, and isotopes can be specified with a number equal to the integer isotopic mass preceding the atomic symbol. Each of the 223 drugs investigated in an example implementation has its unique chemical structure which can be represented as a molecular graph using RDKit software, where the vertices and edges denote chemical atoms and bonds, respectively. Thus, each graph obtained from one line of SMILES contains information about one specific drug and has a number of vertices equal to the number of atoms in the molecule of this drug, and the edges in the graph are responsible for the bonds between atoms in the molecule.

The graph convolutional network comprises a plurality of graph convolutional layers taking two matrices as an input, a feature matrix X∈R^{N×F} and an adjacency matrix A∈R^{N×N}, which displays the connections between atoms, where N is the number of atoms in a molecule, and F corresponds to atomic features encoded in a 78-dimensional binary feature vector.

The graph-convolutional sub-network in the example comprises three graph convolutional layers, with an activation function ReLU used after each of them, and after the last graph convolutional layer, a global max pooling is applied. The obtained output from the graph-convolutional sub-network is turned into another 128-dimensional vector by the sequence of two fully connected neural network layers with feature vector sizes of 312, 1024, and 128 respectively.

Commonly used quantum neural network architectures normally encode each feature on a separate qubit, but for 256 neurons this can be challenging as 1) this qubit count may be the fault-tolerant readily accessible quantum simulator or hardware, and 2) the noise-free barren plateau problem can affect this region with high potency, rendering the model difficult to train. Instead, 8 qubits were used, and the features were encoded in a lattice of quantum operations formed by a plurality of layers of quantum gates 20 of length 32, i.e., 32 encoding layers 22 and variational layers 24.

Each of the 256 features leading up to the quantum layer can be encoded on this lattice in such a way that the first 8 features {φᵢ}ᵢ₌₁⁸, forming a first sub-vector of input data, are encoded on the first lattice layer, features 9-16 {φᵢ}ᵢ₌₉¹⁶ on the second layer, and so on. The classical features are encoded into the quantum Hilbert space, using the “angle embedding” method, which rotates each qubit around the Z-axis on the Bloch sphere by an angle proportional to the corresponding value in the input vector.

To ensure the highest Fourier accessibility to the feature encoding, entangling variational layers 24 are placed between each encoding layer 22. Each variational layer 24 may consist of two parts: rotations with trainable parameters, and control gates, which can be subsequent CNOT operations. The rotations serve as quantum gates that transform the encoded input data according to the variational parameters, while the CNOT operations are used to entangle the qubits in the quantum layer 20, allowing for the creation of quantum superposition. In the illustrated example, the number of variational layers 24 in each lattice layer equals 5, but the variational parameters for each variational layer 24 are different in each of the 5 repetitions. Thus, the total number of weights in the quantum part of the hybrid quantum computation system 10 is calculated as 8.5 (for the initial variational layer 24i)+8·5· 32 and equals 1320.

As already discussed in conjunction with FIG. 5, in the measurement part, all qubits but the first make a CNOT operation on the first qubit so that the Z-measurement is propagated to all qubits. The Z-measurement can be augmented using a multiplicative and an additive trainable parameter to fit the requirements of the IC₅₀ value, as a prediction of the drug response. Thus, the measured output of the hybrid quantum computation system 10 can be used to determine a prediction of an IC₅₀ value of the particular chemical/cell line pair, after a training process.

The hybrid quantum computation system 10 was evaluated on drug/cell line pairs provided by the GDSC database with known IC₅₀ values. The database consisted of 223×948=172,114 pairs of drugs and cell lines. Since it is difficult to collect data in tasks related to the pharmaceutical industry and personal medicine, and the hybrid quantum computation system 10 was found to perform well in solving problems on a small dataset, the dataset was reduced to 5000 samples for training and 1000 for a testing procedure, with a random split of the samples.

The response values were normalized in the range of (0,1) using a logistic-like function, wherein for each IC₅₀ value y, the following formula was applied: norm (y)=1/(1+y^{0.1}), where y>0.

For training purposes, the order of samples in the training set is shuffled at each epoch, while in the testing set it remains the same, to increase the representativeness of the dataset and prevent accidental skewness. As an optimizer, Adam was used with a learning rate equal 1.8×10⁻³, and the hyperparameters were determined through a combination of trial and error and a grid search approach to obtain the best performance on the testing set.

The effectiveness of the system 10 at solving the classification task can be evaluated with the mean square error (MSE) metric as a loss/cost function, which can measure the discrepancy between the predicted IC₅₀ value (Yᵢ) and the corresponding ground-truth value (Oᵢ) for each drug/cell line pair (i) in the dataset. The MSE may be defined as MSE=1/N Σᵢ(Oᵢ−Yᵢ)², where N denotes the number of drug/cell line pairs in the dataset. A successful performance of the model may be determined by small values of the MSE—the lower, the better.

The system 10 was simulated on classical hardware, and to obtain the gradients of the loss function with respect to each of the parameters, for the classical part of the hybrid quantum computation system 10, the standard back propagation algorithm implemented with the PyTorch library was used and for the quantum part, the adjoint method implemented with the PennyLane framework was used.

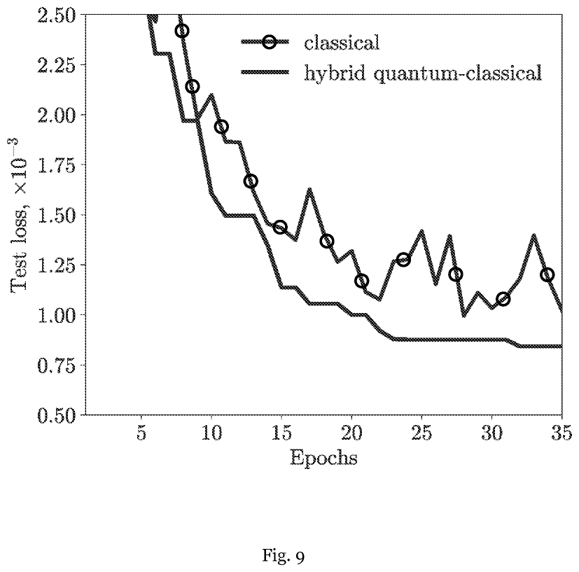

FIG. 9 illustrates simulation results based on training of the simulated hybrid quantum-classical classification system 10 schematically shown in FIG. 8, wherein the Test loss (MSE achieved over the testing samples) is plotted against the number of learning epochs. The system 10 shown in FIG. 8 was compared to a purely classical classifier which differs only in the last part of the machine learning system, i.e. with the same architecture of the first model 30 and the second model 32. However, instead of a variational quantum circuit 28, the classical network has two fully connected layers, the numbers of neurons which are 8 and 1. In terms of the number of parameters, these two classifiers also differ only in the last part: the variational quantum circuit 28 of the hybrid quantum computation system 10 has 1320 variational parameters, while the corresponding classical machine learning model has 2056.

The MSE loss function of the hybrid quantum computation system 10 decreases monotonically during training, while the classical model exhibits a volatile behavior. This indicates that the HQNN may be more stable and efficient in minimizing the loss function.

This can be attributed to the inherent properties of quantum computing, such as superposition and entanglement, which can enhance the ability of the classifier to learn complex relationships and patterns in the data. These properties can also help avoid overfitting and improve generalization, leading to better performance on unseen data. Therefore, by utilizing quantum computing in machine learning, more robust and reliable classifiers that can contribute to a better understanding of complex systems, such as drug response prediction, may be achieved.

The classifier with the variational quantum circuit 28 in the example demonstrates a better result than the purely classical one and the improvement in the loss of the hybrid quantum computation system 10 is more than 15% compared to the classical classifier with the same architecture.

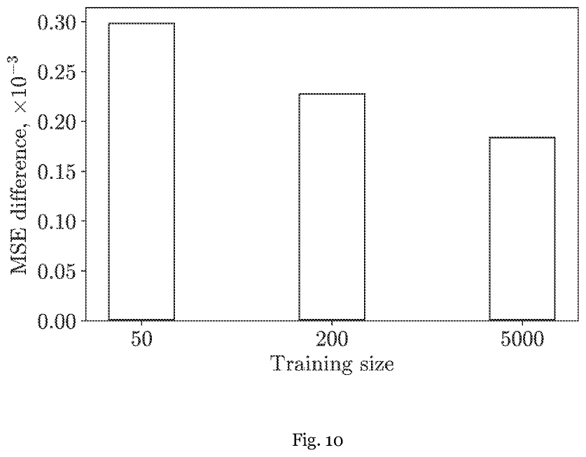

FIG. 10 illustrates simulation results of training the hybrid and classical models with the same hyperparameters on a different amount of training data: on 50, 200, 5000 numbers of samples. The Y-axis shows the difference in MSE loss on the testing set, which consisted of 10, 50, 1000 data points, respectively to maintain the training/testing ratio, between the hybrid and classical models. As one can see from the graph, the less training data—the greater the difference in loss—the better the quantum model is compared to the classical one. This suggests that HQNNs are particularly useful for tasks such as personalized medicine, where obtaining large amounts of data may be challenging, and where classical neural networks may encounter issues such as overfitting or underfitting. Moreover, the structure of the variational quantum circuit 28 allows for applications where the number of data features exceeds the qubit count.

The description of the detailed embodiments and the figures merely serve to illustrate the invention and the beneficial effects associated therewith but should not be understood to imply any limitation. The scope of the invention is to be determined solely by the appended claims.

### LIST OF REFERENCE SIGNS

10 system
12 qubit register
14 plurality of quantum gates
16 measurement sensors
18 control system
20 layers of quantum gates
22 encoding layer
24 variational layer
24i initial variational layer
26 sub-vector of input data
28 variational quantum circuit
29 plurality of multi-qubit gates
30 first model
32 second model

In a general aspect of the present disclosure, a quantum computation system implementing the method may generally comprise a plurality of computation qubits, whose quantum states may be manipulated by the application of quantum gates applied in sequence or in parallel to single qubits or multiple qubits.

The computation qubits can be initialized into the initial state, such as the ground state of each qubit. The initialization of the computation qubits into their respective ground state may in some examples comprise a relaxation process, and the initialization of the computation qubits may not require active control of the computation qubits. In some examples, after initialization of the qubits into their ground states, superposition states of computation qubits in the qubit register are prepared, e.g. via the application of Hadamard gates.

Subsequently, a plurality of quantum gates can be applied to the computation qubits to transform their quantum state towards an output state as part of a variational quantum circuit. In variational quantum circuits, the action of at least some of the quantum gates in the variational quantum circuit is parametrized, such that a measured output of the computation qubits is a function of variational parameters parametrizing variable actions of the variational quantum gates, such as a rotation angle. The combined action of the at least partially parametrized quantum gates may be termed a variational quantum circuit.

The layers of quantum gates may act on the computation qubits to link the computation qubits in the variational quantum circuit. The layers of quantum gates may comprise a cumulative action of a plurality of coherent operations on the state of the qubits in the qubit register. The cumulative action of the coherent operations in one layer can act on all computation qubits which are involved in the computation, or in other words, a layer of quantum gates may directly affect the state of all computation qubits. Each layer should comprise at least one multi-qubit gate and comprises at least one variational quantum gate, which in principle could be the same gates.

The skilled person will appreciate that a plurality of the quantum gates in a layer may be applied in parallel to the qubits to shorten the sequence of coherent operations on the state of the qubits in a layer.

The subsequent application of a plurality of layers of quantum gates to the qubits may form the variational quantum circuit, with the variational quantum circuit being parametrized by variational parameters for each layer.

Each layer of quantum gates may comprise an entangling gate for each of the computation qubits, such as to create a superposition state of the computation qubits. In some examples, each layer of quantum gates is configured to entangle the states of each computation qubit with at least one other qubit of the computation qubits. In some examples, each layer comprises a plurality of entangling gates to create a superposition state of all the computation qubits.

Superposition states between the computation qubits may be created by suitable two- or multi-qubit gates, wherein such quantum gates may also be referred to as entangling gates in the following. For example, when the variational quantum circuit is implemented in a quantum device based on a trapped ion system, the states of different ions in the trapped ion system may be coupled through a joint excitation, e.g., mediated via the Mølmer-Sørensen interaction. As another example, pairs of qubits in the qubit register may be entangled via a (tunable) nearest neighbor interaction or exchange of a quantum particle, in order to implement a two-qubit gate, such as a CNOT gate, as an entangling gate.

The layers may contain the same types of quantum gates, and the layers may be applied sequentially to the qubit register. For example, each layer may feature the same architecture of quantum gates, while different elements of the variational parameters may apply to the variational gates of the layer. In other words, the layers may feature the same quantum gate architecture, but the action of the quantum gates on the qubits in each layer may differ based on the variational parameters or the input vector of features for the respective layer.

In some examples, the layers of quantum gates comprise the same arrangement of quantum gates in each layer and the quantum gates in each layer may comprise a plurality of multi-qubit quantum gates which together act on all qubits of the qubit register.

In addition, each of the layers of quantum gates may comprise a plurality of encoding gates for encoding the features of one of the sub-vectors into the computation qubits, with the sub-vectors of input data for two different layers of quantum gates being different. As a result, different layers of quantum gates may encode different parts of the input vector of features. In other words, the encoding gates in two different layers may encode different features of the input vector of features, such as to increase a number of features encoded in each qubit of the respective variational quantum circuit, at the expense of additional gates as part of the quantum circuits.

To encode the values of the input vector of features into the quantum Hilbert space, the “angle embedding” method can be utilized, which involves rotating the respective qubit around an axis, such as the Z-axis (it can also be the X or Y-axis) on the Bloch sphere by an angle proportional to a value corresponding the respective feature.

The values of the input vector of features may be encoded over a plurality of different layers of quantum gates, such that the input vector of features may be distributed over multiple layers of quantum gates.

To ensure maximum Fourier accessibility to the feature encoding, entangling variational layers can be placed between each encoding layer. In some examples, each encoding layer may have at most one encoding gate per computation qubit or may encode at most one feature per computation qubit. Each variational layer may be composed of rotations with trainable parameters and control gates for coupling different qubits, such as CNOT operations.

The variational gates of each layer of quantum gates may act on the computation qubits, such as to access a different part of a Hilbert space spanned by the states of the computation qubits for encoding feature values with the encoding gates acting on the computation qubits in different layers. Thus, the different values of the input vector of features may be effectively stored in different parts of a Hilbert space based on the action of the variational quantum circuit.

In some examples, the variational quantum circuit comprises a number of n computation qubits, and the number of encoding gates in each layer is smaller or equal to n.

Each layer may encode one value of the input vector of features to a respective one of the computation qubits.

In some examples, each layer comprises a number of n encoding gates, wherein each of the n encoding gates acts on a respective one of the n computation qubits.

The input vector of features may comprise a number of Nf input features, with Nf being greater than a dimension of the sub-vectors, such that different sub-vectors comprise different input features of the input vector of features. In some examples, different layers of quantum gates encode different sub-sets of the Nf input features.

In some examples, each sub-vector of input data comprises a number of n features, and each input feature of the sub-vector is encoded to a respective one of the n computation qubits.

If the input vector of features has a size that is not divisible by n, dummy values, such as zeros may be padded on the input vector of features to the input vector features until it does. Additionally, or alternatively, some of the input values of another one of the sub-vectors may be repeated in one of the other sub-vectors of features, such as to pad the respective sub-vector of input features and implement a data-reuploading of specific features at the same time. For example, if the input vector of features initially has 110 features and 20 computation qubits are available, 10 dummy input feature values, such as zeros or ones, may be added to the input vector of features, or 10 of the previous feature values may be repeated, so that the input vector of features comprises 120 feature values and may be split into 6 sub-vectors of identical length. In some examples, one of the layers of quantum gates may comprise a number of encoding gates which is different, such as smaller, from the number of computation qubits.

In some examples, the variational quantum circuit comprises a number of n computation qubits, and each layer comprises a number of n encoding gates and a plurality of variational gates, wherein each of the n encoding gates act on a respective one of the n computation qubits.

Each layer may comprise a number of variational gates which may be based on the number of computation qubits, and may be more or less than n. For example, each layer could comprise n/2, n, 2n or 3n variational gates. In some examples, a variational gate is applied to each one of the computation qubits between applications of encoding gates to that computation qubit. In some examples, a layer of quantum gates comprises the action of an encoding gate, a variational gate and an entangling gate applied to each one of the computation qubits.

In some examples, each layer of quantum gates comprises an encoding layer and a variational layer, wherein the encoding layer encodes a respective subset of features into the state of the computation qubits, and wherein the variational layer acts on the state of the computation qubits based on a set of variational parameters for that layer.

In some examples, the layer of quantum gates comprises a plurality of variational layers, wherein each of the variational layers comprises variational gates acting on the quantum states of each of the computation qubits.

The plurality of variational layers may improve a processing of different input features encoded in different encoding layers, such that the number of variational gates in each layer may be greater than the number of encoding gates. In some examples, in each layer of quantum gates, the number of encoding gates is smaller than the number of variational gates. In some examples, in each layer of quantum gates, a greater number of variational gates acts on each one of the computation qubits than the number of encoding gates for the one of the computation qubits.

In some examples, the variational layer is an entangling variational layer, wherein the entangling variational layer comprises entangling gates for entangling the states of the computation qubits and variational gates acting on the quantum states of each of the computation qubits.

In some examples, the encoding gates comprise single qubit rotations proportional to a value of the input vector of features. The encoding gate may be applied a number of k times as part of the variational quantum circuit, wherein k is an integer value greater than 2, and wherein the variational quantum circuit may be parametrized by at least 2k variational parameters. Applying the encoding gate multiple times may implement a re-uploading of the input vector of features into the variational quantum circuit, such that the variational quantum circuit may fit a higher order Fourier series to the labelling function for that value of the input vector of features.

After the layers of quantum gates have acted on the qubits, the states of the qubits can be measured to obtain a characteristic measured outcome of the variational quantum circuit with respect to the input vector of features. The outcome of the quantum mechanical computation may be linked to the output label of the classification task via the computational basis states of the qubits. The computational basis states may be orthogonal basis states of the Hilbert space spanned by the tensor product of the basis states of each qubit. The method may comprise determining a measured output indicative of a state of the computation qubits. A measurement of a quantum system may be non-deterministic and may project the state of the computation qubits onto the computational basis states. Measuring the computation qubits multiple times, may allow determining probabilities of measuring each of the computational basis states of the qubits for the quantum state produced by the application of the plurality of quantum gates.

Initial variational parameters for the variational quantum gates can encode an initial (random) guess for an optimal classifier, and the outcome of the evaluation of the variational quantum circuit with the variational parameters can be measured (repeatedly) to determine a corresponding label. Based on the label, a cost function may be classically evaluated to attribute a cost to the label, or in other words, a measure is calculated of how good the label is.

Usually, the variable parameters are subsequently updated (iteratively) using a feedback-loop implemented in a classical processing system, such that the output approaches an optimal solution, i.e., an optimal label given the labeling task, making the overall method including the operation of the variational quantum circuit and its control/optimization a hybrid quantum-classical algorithm.

The feedback loop may also optimize an encoding of the input vector of features into different parts of the Hilbert space of the computation qubits, such that the optimization of the variational parameters may optimize both the encoding of large input vectors of features into a limited number of qubits as well as the processing of the information by the variational quantum circuit to label the input vector of features given the labeling task.

By training the system, the variational parameters may be systematically varied in an iterative manner, such that the variational quantum circuit approximates the output label.

The trainable parameters may be updated with known techniques employed in classical machine learning, such as gradient based optimization algorithms, e.g. stochastic gradient descent or adaptive moment estimation, or gradient free optimization, such as simulated annealing. Preferably, the optimization algorithm is gradient based, and the method may comprise determining a gradient of the trainable parameters with respect to the cost attributed to the output label by the cost function.

In some examples, obtaining a quantum computation system for predicting the output label for an input vector of features comprises determining a number of computation qubits for defining the quantum computation system, dividing the number of features in the input vector of features by the number of qubits to determine a number of sub-vectors of input data, determining encoding layers for each one of the sub-vectors of input data, wherein each of the encoding layers comprises a number of encoding gates equal to the number of computation qubits, determining a variational quantum circuit, wherein the encoding layers are applied to the computation qubits with layers of variational quantum gates in alternating fashion, implementing the variational quantum circuit in the quantum computation system comprising the plurality of computation qubits, and varying variational parameters of the layers of variational quantum gates according to a training algorithm, such that the variational quantum circuit predicts a target output label for a given input vector of features.

In some examples, the training algorithm comprises applying the variational quantum circuit to a sample input vector of features; determining a cost associated with an output label for the sample input vector of features, wherein the output label is based on a measured output state of the variational quantum circuit for the input vector of features, and determining an update for the variational parameters based on the cost.

The variational quantum circuit may be configured to act on at least two qubits in its associated qubit register. The variational quantum circuit may in principle be designed according to an availability of quantum processing resources, wherein an increased number of qubits may generally increase the Fourier space accessible and thereby the complexity of the internal computation performed by the variational quantum circuit.

The variational quantum circuit may be implemented in quantum hardware. In the preliminary experiments of the inventors, the variational quantum circuits were generally implemented in a simulation of a quantum device running on classical hardware. Even a simulated variational quantum circuit may be beneficial in some examples, and the variational quantum circuit may therefore be implemented on a classical computer using a quantum simulator. However, the system is preferably implemented with the variational quantum circuits implemented in quantum hardware, such as to reduce a classical processing power and computation time required for simulating complex quantum hardware.

The output of the variational quantum circuit may be measured as a measured output, e.g., between 0 and 1 for each of the qubits. Said measured output may subsequently be used by the system to determine the output label/class corresponding to the input vector of features, e.g., by a pre-determined mapping or using a classical machine learning model for interpreting the output of the variational quantum circuit, which may be trained jointly or independently with respect to the variational parameters of the variational quantum circuit.

The labeling task may be a classification task for a set of input data values and may be similar to the classification tasks encountered in classical machine learning, such as image classification, prediction of an optimal action based on a given set of state information, or estimating a solution to a problem considered to be computationally difficult, e.g. estimating parameters of a fluid dynamics problem, satellite mission planning, traveling salesman problems, or drug response prediction, just to give some examples.

The labeling task may comprise determining an optimal output label, e.g., an optimal next node during satellite mission planning, based on a set of data values provided to the input vector of features, such as a current snapshot state of operating parameters and known information, e.g., the location, of the satellite. Thus, a vector of input features reflecting the set of data values may be encoded into the quantum states of the computation qubits, and the measured output of the variational quantum circuit may be used to determine the output label for the set of input features, which best solves the labeling task based on a previous training process of the variational parameters.

The values of the input vector or features may be obtained from the set of input data values through a transformation, such as a scaling function, e.g., to scale an input value to a range of angles between 0 and 2x, as part of a suitable normalization function.

In some examples, the variational quantum circuit may be combined with a classical machine learning classifier, e.g., a neural network based on artificial neurons, to solve the labeling task, such as to process an output of a classical machine learning classifier with the variational quantum circuit, provide an output for a classical machine learning classifier based on the measured output of the variational quantum circuit, or both. The classical machine learning classifiers may be trained jointly or separately with the optimization of the variational parameters.

According to a second aspect, a method for training a quantum computation system to label an input vector of features with an output label using a variational quantum circuit is provided, wherein the quantum computation system comprises a plurality of computation qubits and a control system. The method comprises an iterative process of separating the input vector of features into a plurality of sub-vectors of input data, initializing the computation qubits in an initial state, subjecting a plurality of computation qubits to a plurality of layers of quantum gates, determining a candidate label for the input vector of features based on a measured output state of the computation qubits, and determining an update to the variational parameters based on cost associated with the candidate label for the input vector of features, wherein the cost is determined based on a cost function. Each layer of the plurality of layers of quantum gates comprises an entangling gate for entangling quantum states of at least two qubits of the computation qubits, a plurality of encoding gates for encoding the features of one of the sub-vectors into the computation qubits, and a plurality of variational gates acting on the computation qubits according to a variational parameter associated with the respective layer and variational gate. The sub-vectors of input data for two different layers of quantum gates are different.

In some examples, the method comprises determining a gradient of the cost function with respect to the variational parameters, wherein the variational parameters are updated based on the gradient.

In some examples, the method comprises determining a plurality of partial derivatives of the plurality of variational quantum gates with respect to the variational parameters based on measured outputs of the variational quantum circuit for varied variational parameters and determining a gradient of a cost function based on the plurality of partial derivatives of the set of quantum gates.

In some examples, the cost function is based on the candidate output label and a sample label for the input vector of features.

According to a third aspect, a quantum computation system for labeling an input vector of features with an output label with a variational quantum circuit given a labeling task is provided. The quantum computation system comprises a plurality of computation qubits and a control system. The control system is configured to separate the input vector of features into a plurality of sub-vectors of input data, initialize the computation qubits in an initial state, and apply a plurality of layers of quantum gates to the computation qubits. Each layer of the plurality of layers of quantum gates comprises an entangling gate for entangling quantum states of at least two qubits of the computation qubits, a plurality of encoding gates for encoding the features of one of the sub-vectors into the computation qubits, and a plurality of variational gates acting on the computation qubits according to a variational parameter associated with the respective layer and variational gate. The sub-vectors of input data for two different layers of quantum gates are different, and the variational parameters are trained according to a training algorithm for predicting an optimal output label for the input vector of features in view of the labeling task.

The system may implement the method according to the first aspect or the second aspect or any combination of their examples. In particular, the system according to the third aspect may also benefit from any feature of the examples for the first aspect or the second aspect.

The system may comprise or be controlled using a processing system, which may comprise a single processing unit or may comprise a plurality of processing units, which may be functionally connected. The processing units may comprise a microcontroller, an ASIC, a PLA (CPLA), an FPGA, or other processing device, including processing devices operating based on software, hardware, firmware, or a combination thereof. The processing devices can include an integrated memory, or communicate with an external memory, or both, and may further comprise interfaces for connecting to sensors, devices, appliances, integrated logic circuits, other controllers, or the like, wherein the interfaces may be configured to receive or send signals, such as electrical signals, optical signals, wireless signals, acoustic signals, or the like.

The system may comprise multiple servers for executing different steps. However, the processing steps of the processing system may equally be executed by a single server or a server system, which may distribute internal computations over multiple processing devices.

In some examples, the control system comprises a classical processing system implemented in classical hardware. The classical processing system is configured to implement one or more of: determining encoding gate actions for the input vector of features and sending the encoding gate actions to quantum control hardware of the quantum computation system for executing the variational quantum circuit; sending an initialization command to the quantum control hardware for initializing the computation qubits in the initial state; sending a control command to the quantum control hardware to apply the layers of quantum gates to the computation qubits; and retrieving a measurement result for the state of the quantum computation qubits after the layers of quantum gates have been applied to the quantum computation qubits.

A hybrid quantum-classical computation system may be implemented with a classical processing system, which may comprise classical processing resources processing binary features based on a deterministic algorithm, and a quantum processing system implemented with a plurality of computation qubits which can be coherently manipulated with control operations. The quantum processing system may comprise hardware for implementing quantum gates, such as by controlling an evolution of a state of a qubit, e.g. through controlling an action of function generators or lasers on the computation qubits. The classical processing system may determine the quantum circuit, the variational parameters, an encoding gate action based on input features, or a combination thereof, and may initiate or control an action of the hardware for manipulating the quantum state of the computation qubits. The classical processing system may receive and process a measured output of the variational quantum circuit and may determine updated variational parameters or an output label based on the measured output.

In some examples, the control system is configured to implement the training algorithm, wherein the training algorithm comprises: obtain a sample input vector of features, implement the variational quantum circuit with the plurality of encoding gates encoding the sample vector of input features and based on a set of variational parameters, retrieve a measured output of the variational quantum circuit for the sample input vector of features, evaluate a cost function attributing a cost to the output label derived from the measured output, and update the set of variational parameters based on the cost.

According to a fourth aspect, a non-transitory medium comprising machine-readable instruction is provided, which, when executed by a processing system, implement a method according to the first aspect or the second aspect or a system according to the third aspect.

The machine-readable instruction may coordinate a training of the hybrid quantum-classical computation system or may implement a hybrid quantum-classical computation system for approximating a given labelling function based on previously obtained trainable parameters.

The machine-readable instruction may configure the plurality of variational quantum circuits, e.g., by determining an architecture or variational parameters of the variational quantum circuits. During an implementation of the system or method, the computer program may provide the input vector of features to the variational quantum circuit and may receive measured outputs of the variational quantum circuit.

In some examples, the machine-readable instruction determines parameter updates for the variational parameters.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for labeling an input vector of features with an output label using a variational quantum circuit given a labeling task, comprising:
separating the input vector of features into a plurality of sub-vectors of input data;
initializing a plurality of computation qubits in an initial state;
subjecting the plurality of computation qubits to a plurality of layers of quantum gates, wherein each layer of the plurality of layers of quantum gates comprises:
an entangling gate for entangling quantum states of at least two qubits of the computation qubits,
a plurality of encoding gates for encoding the features of one of the sub-vectors into the computation qubits, and
a plurality of variational gates acting on the computation qubits according to a variational parameter associated with the respective layer and variational gate;
wherein the sub-vectors of input data for two different layers of quantum gates are different; and
wherein the variational parameters are optimized for predicting an optimal output label for the input vector of features in view of the labeling task according to a training algorithm.

2. The method of claim 1, wherein the variational quantum circuit comprises a number of n computation qubits, wherein each layer comprises a number of n encoding gates, and wherein each of the n encoding gates acts on a respective one of the n computation qubits.

3. The method of claim 2, wherein the number of encoding gates is smaller or equal to n.

4. The method of claim 2, wherein each sub-vector of input data comprises a number of n features, and wherein each input feature of the sub-vector is encoded to a respective one of the n computation qubits.

5. The method of claim 1, wherein the input vector of features comprises a number of Nf input features, which is greater than a dimension of the sub-vectors, such that different sub-vectors comprise different input features of the input vector of features.

6. The method of claim 5, wherein different layers of quantum gates encode different sub-sets of the Nf input features.

7. The method of claim 1, wherein each layer of quantum gates is configured to entangle the states of each computation qubit with at least one other qubit of the computation qubits.

8. The method of claim 1, wherein each layer of quantum gates comprises an encoding layer and a variational layer, wherein the encoding layer encodes a respective subset of features into the state of the computation qubits, and wherein the variational layer acts on the state of the computation qubits based on a set of variational parameters for that layer.

9. The method of claim 8, wherein the layer of quantum gates comprises a plurality of variational layers, wherein each of the variational layers comprises variational gates acting on the quantum states of each of the computation qubits.

10. The method of claim 8, wherein the variational layer is an entangling variational layer, wherein the entangling variational layer comprises entangling gates for entangling the states of the computation qubits and variational gates acting on the quantum states of each of the computation qubits.

11. The method of claim 8, wherein in each layer of quantum gates, the number of encoding gates is smaller than the number of variational gates.

12. The method of claim 11, wherein in each layer of quantum gates, a greater number of variational gates acts on each one of the computation qubits than the number of encoding gates for the one of the computation qubits.

13. The method of claim 1, wherein obtaining a quantum computation system for predicting the output label for an input vector of features comprises:
determining a number of computation qubits for defining the quantum computation system;
dividing the number of features in the input vector of features by the number of qubits to determine a number of sub-vectors of input data;
determining encoding layers for each one of the sub-vectors of input data, wherein each of the encoding layers comprises a number of encoding gates equal to the number of computation qubits;
determining a variational quantum circuit, wherein the encoding layers are applied to the computation qubits with layers of variational quantum gates in alternating fashion;
implementing the variational quantum circuit in the quantum computation system comprising the plurality of computation qubits,
varying variational parameters of the layers of variational quantum gates according to a training algorithm, such that the variational quantum circuit predicts a target output label for a given input vector of features.

14. The method of claim 1, wherein the training algorithm comprises applying the variational quantum circuit to a sample input vector of features; determining a cost associated with an output label for the sample input vector of features, wherein the output label is based on a measured output state of the variational quantum circuit for the input vector of features and determining an update for the variational parameters based on the cost.

15. A method for training a quantum computation system to label an input vector of features with an output label using a variational quantum circuit, wherein the quantum computation system comprises a plurality of computation qubits and a control system, the method comprising an iterative process of:
separating the input vector of features into a plurality of sub-vectors of input data;
initializing the computation qubits in an initial state;
subjecting a plurality of computation qubits to a plurality of layers of quantum gates, wherein each layer of the plurality of layers of quantum gates comprises:
an entangling gate for entangling quantum states of at least two qubits of the computation qubits,
a plurality of encoding gates for encoding the features of one of the sub-vectors into the computation qubits, and
a plurality of variational gates acting on the computation qubits according to a variational parameter associated with the respective layer and variational gate;
wherein the sub-vectors of input data for two different layers of quantum gates are different;
determining a candidate label for the input vector of features based on a measured output state of the computation qubits; and
determining an update to the variational parameters based on cost associated with the candidate label for the input vector of features, wherein the cost is determined based on a cost function.

16. The method of claim 15, wherein the method comprises determining a gradient of the cost function with respect to the variational parameters, wherein the variational parameters are updated based on the gradient.

17. The method of claim 15, wherein the method comprises determining a plurality of partial derivatives of the plurality of variational quantum gates with respect to the variational parameters based on measured outputs of the variational quantum circuit for varied variational parameters and determining a gradient of a cost function based on the plurality of partial derivatives of the set of quantum gates.

18. A quantum computation system for labeling an input vector of features with an output label with a variational quantum circuit given a labeling task, wherein the quantum computation system comprises a plurality of computation qubits and a control system, wherein the control system is configured to:
separate the input vector of features into a plurality of sub-vectors of input data;
initialize the computation qubits in an initial state;
apply a plurality of layers of quantum gates to the computation qubits, wherein each layer of the plurality of layers of quantum gates comprises:
an entangling gate for entangling quantum states of at least two qubits of the computation qubits,
a plurality of encoding gates for encoding the features of one of the sub-vectors into the computation qubits, and
a plurality of variational gates acting on the computation qubits according to a variational parameter associated with the respective layer and variational gate;
wherein the sub-vectors of input data for two different layers of quantum gates are different;
wherein the variational parameters are trained according to a training algorithm for predicting an optimal output label for the input vector of features in view of the labeling task.

19. The quantum computation system of claim 18, wherein the control system comprises a classical processing system implemented in classical hardware, wherein the classical processing system is configured to implement one or more of:
determining encoding gate actions for the input vector of features and sending the encoding gate actions to quantum control hardware of the quantum computation system for executing the variational quantum circuit;
sending an initialization command to the quantum control hardware for initializing the computation qubits in the initial state;
sending a control command to the quantum control hardware to apply the layers of quantum gates to the computation qubits; and
retrieving a measurement result for the state of the quantum computation qubits after the layers of quantum gates have been applied to the quantum computation qubits.

20. The quantum computation system of claim 18, wherein the control system is configured to implement the training algorithm, wherein the training algorithm comprises:
obtain a sample input vector of features;
implement the variational quantum circuit with the plurality of encoding gates encoding the sample vector of input features and based on a set of variational parameters;
retrieve a measured output of the variational quantum circuit for the sample input vector of features;
evaluate a cost function attributing a cost to the output label derived from the measured output; and
update the set of variational parameters based on the cost.
